(19) United States
(12) Patent Application Publication
(10) Pub. No.: US 2021/0296990 A1
(43) Pub. Date: Sep. 23, 2021

(54) BUCK CONVERTER

(71) Applicant: Acer Incorporated, New Taipei City (TW)

(72) Inventor: Tzu-Tseng CHAN, New Taipei City (TW)

(21) Appl. No.: 16/988,065

(22) Filed: Aug. 7, 2020

(30) Foreign Application Priority Data
Mar. 18, 2020 (TW) 109108941

(51) Int. Cl. H02M 3/158; H02M 7/219; H02M 1/08

(52) U.S. Cl. CPC H02M 3/1588; H02M 1/08; H02M 7/219

(57) ABSTRACT

A buck converter includes a bridge rectifier, a power switch element, an output stage circuit, a first diode, a first inductor, and a detection and compensation circuit. The bridge rectifier generates a rectified voltage according to the first input voltage and the second input voltage. The power switch element selectively couples the bridge rectifier to the ground voltage according to the clock voltage. The output stage circuit generates an output voltage. The first inductor is coupled between the detection and compensation circuit and the output stage circuit. The detection and compensation circuit monitors and compares the rectified voltage and the output voltage. If it is detected that the rectified voltage is lower than the output voltage, the detection and compensation circuit will readjust the rectified voltage so that it is higher than or equal to the output voltage.

### CROSS REFERENCE TO RELATED APPLICATIONS

This application claims priority of Taiwan Patent Application No. 109108941 filed on Mar. 18, 2020, the entirety of which is incorporated by reference herein.

### BACKGROUND OF THE INVENTION

### Field of the Invention

The disclosure generally relates to a buck converter, and more specifically, to a buck converter with high conversion efficiency.

### Description of the Related Art

Generally, a low-Watt power supply device usually uses a buck converter to increase the power factor. However, if the input (rectified) voltage in a conventional buck converter is lower than its output voltage, a “dead zone” may occur, possibly resulting in a malfunction of the whole circuitry, as well as poor conversion efficiency. Accordingly, there is a need to propose a novel solution for solving the problems of the prior art.

### BRIEF SUMMARY OF THE INVENTION

In a preferred embodiment, the invention is directed to a buck converter that includes a bridge rectifier, a power switch element, an output stage circuit, a first diode, a first inductor, and a detection and compensation circuit. The bridge rectifier generates a rectified voltage according to a first input voltage and a second input voltage. The power switch element selectively couples the bridge rectifier to a ground voltage according to a clock voltage. The output stage circuit generates an output voltage. The first inductor is coupled between the detection and compensation circuit and the output stage circuit. The detection and compensation circuit monitors and compares the rectified voltage and the output voltage. The first diode is coupled to the detection and compensation circuit and the first inductor. If it is detected that the rectified voltage is lower than the output voltage, the detection and compensation circuit will readjust the rectified voltage, such that the readjusted rectified voltage can be higher than or equal to the output voltage.

### BRIEF DESCRIPTION OF DRAWINGS

The invention can be more fully understood by reading the subsequent detailed description and examples with references made to the accompanying drawings, wherein:

FIG. 1 is a diagram of a buck converter according to an embodiment of the invention;

FIG. 2 is a diagram of a buck converter according to an embodiment of the invention;

FIG. 3 is a diagram of a waveform of a rectified voltage of a conventional buck converter; and

FIG. 4 is a diagram of a waveform of a rectified voltage of a buck converter according to an embodiment of the invention.

### DETAILED DESCRIPTION OF THE INVENTION

In order to illustrate the purposes, features and advantages of the invention, the embodiments and figures of the invention are described in detail as follows:

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

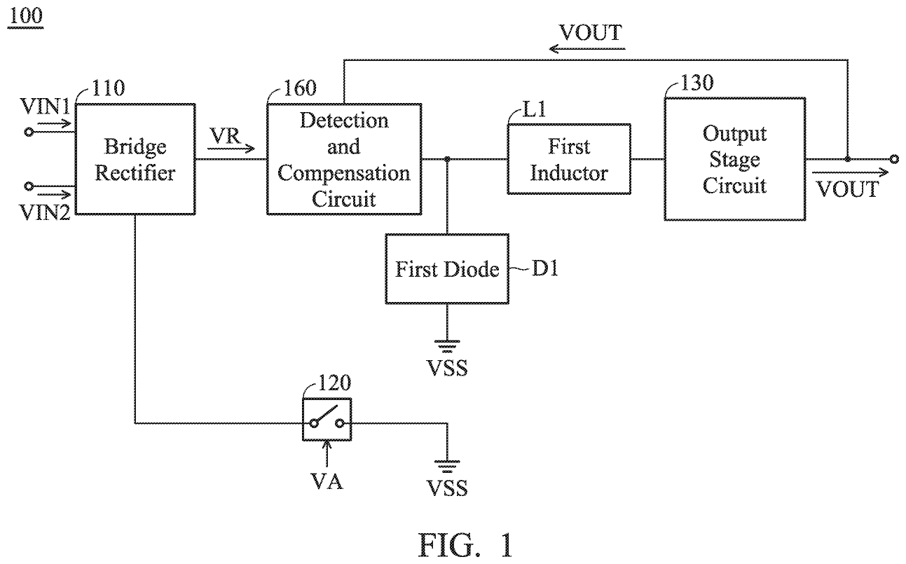

FIG. 1 is a diagram of a buck converter 100 according to an embodiment of the invention. For example, the buck converter 100 may be applied to a power supply device, but it is not limited thereto. As shown in FIG. 1, the buck converter 100 includes a bridge rectifier 110, a power switch element 120, an output stage circuit 130, a first diode D1, a first inductor L1, and a detection and compensation circuit 160. It should be noted that the buck converter 100 may further include other components, such as a voltage regulator and/or a negative feedback circuit, although they are not displayed in FIG. 1.

The bridge rectifier 110 generates a rectified voltage VR according to a first input voltage VIN1 and a second input voltage VIN2. The first input voltage VIN1 and the second input voltage VIN2 may be from an external input power source. An AC (Alternating Current) voltage difference with any frequency and any magnitude may be formed between the first input voltage VIN1 and the second input voltage VIN2. For example, the frequency of the AC voltage difference may be about 50 Hz or 60 Hz, and the RMS (Root-Mean-Square) value of the AC voltage difference may be from 90V to 264V, but it is not limited thereto. The power switch element 120 selectively couples the bridge rectifier 110 to a ground voltage VSS (e.g., 0V) according to a clock voltage VA. When the buck converter 100 is initialized, the clock voltage VA may be maintained at a constant voltage. After the buck converter 100 is operated normally, the clock voltage VA can provide a periodic clock waveform. For example, if the clock voltage VA has a high logic level (e.g., a logic “1”), the power switch element 120 may couple the bridge rectifier 110 to the ground voltage VSS (i.e., the power switch element 120 is similar to a short-circuited path). Conversely, if the clock voltage VA has a low logic level (e.g., a logic “0”), the power switch element 120 may not couple the bridge rectifier 110 to the ground voltage VSS (i.e., the power switch element 120 is similar to an open-circuited path). The output stage circuit 130 generates an output voltage VOUT, which is substantially a DC (Direct Current) voltage. The first inductor L1 is coupled between the detection and compensation circuit 160 and the output stage circuit 130. The first diode D1 is coupled to the detection and compensation circuit 160 and the first inductor L1. The detection and compensation circuit 160 can monitor and compare the rectified voltage VR and the output voltage VOUT. Specifically, if it is detected that the rectified voltage VR is lower than the output voltage VOUT, the detection and compensation circuit 160 will readjust the rectified voltage VR, such that the readjusted rectified voltage VR can be higher than or equal to the output voltage VOUT. Conversely, if it is detected that the rectified voltage VR is higher than or equal to the output voltage VOUT, the detection and compensation circuit 160 will not readjust the rectified voltage VR. With such a design, since the detection and compensation circuit 160 guarantees that the rectified voltage VR should be higher than or equal to the output voltage VOUT, there can be no dead zone occurring in all of the operation cycles of the buck converter 100. Accordingly, the conversion efficiency of the buck converter 100 is significantly increased.

The following embodiments will introduce the detailed structure and operation of the buck converter 100. It should be understood these figures and descriptions are merely exemplary, rather than limitations of the invention.

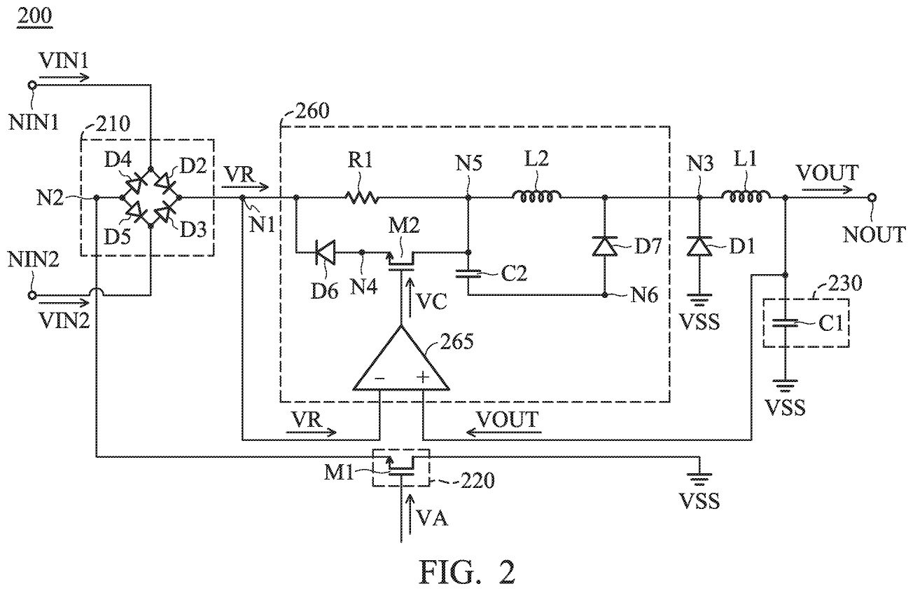

FIG. 2 is a diagram of a buck converter 200 according to an embodiment of the invention. In the embodiment of FIG. 2, the buck converter 200 with a first input node NIN1, a second input node NIN2 and an output node NOUT includes a bridge rectifier 210, a power switch element 220, an output stage circuit 230, a first diode D1, a first inductor L1, and a detection and compensation circuit 260. The first input node NIN1 and the second input node NIN2 of the buck converter 200 are arranged for receiving a first input voltage VIN1 and a second input voltage VIN2 from an external input power source, respectively. An AC voltage difference with any frequency and any magnitude may be formed between the first input voltage VIN1 and the second input voltage VIN2. The output node NOUT of the buck converter 200 is arranged for outputting an output voltage VOUT, which is substantially a DC voltage.

The bridge rectifier 210 includes a second diode D2, a third diode D3, a fourth diode D4, and a fifth diode D5. The second diode D2 has an anode coupled to the first input node NIN1, and a cathode coupled to a first node N1 for outputting a rectified voltage VR. The third diode D3 has an anode coupled to the second input node NIN2, and a cathode coupled to the first node N1. The fourth diode D4 has an anode coupled to a second node N2, and a cathode coupled to the first input node NIN1. The fifth diode D5 has an anode coupled to the second node N2, and a cathode coupled to the second input node NIN2.

The power switch element 220 includes a first transistor M1, which is considered as a main switch element of the buck converter 200. The first transistor M1 may be an NMOS transistor (N-type Metal Oxide Semiconductor Field Effect Transistor). The first transistor M1 has a control terminal for receiving a clock voltage VA, a first terminal coupled to the second node N2, and a second terminal coupled to a ground voltage VSS (e.g., 0V). For example, when the buck converter 200 is initialized, the clock voltage VA may be maintained at a constant voltage (e.g., the ground voltage VSS). After the buck converter 200 is operated normally, the clock voltage VA can provide a periodic clock waveform. In some embodiments, if the clock voltage VA has a high logic level, the first transistor M1 will be enabled, and conversely, if the clock voltage VA has a low logic level, the first transistor M1 will be disabled.

The first diode D1 has an anode coupled to the ground voltage VSS, and a cathode coupled to a third node N3.

The output stage circuit 230 includes a first capacitor C1. The first capacitor C1 has a first terminal coupled to the output node NOUT, and a second terminal coupled to the ground voltage VSS.

The first inductor L1 is considered as a buck inductor of the buck converter 200. The first inductor L1 has a first terminal coupled to the third node N3, and a second terminal coupled to the output node NOUT.

The detection and compensation circuit 260 includes a comparator 265, a second transistor M2, a sixth diode D6, a seventh diode D7, a resistor R1, a second inductor L2, and a second capacitor C2. The comparator 265 may be implemented with an operational amplifier. Specifically, the comparator 265 has a positive input terminal for receiving the output voltage VOUT, a negative input terminal for receiving the rectified voltage VR, and an output terminal for outputting a control voltage VC. For example, if the rectified voltage VR is lower than the output voltage VOUT, the comparator 265 may output the control voltage VC with a high logic level. Conversely, if the rectified voltage VR is higher than or equal to the output voltage VOUT, the comparator 265 may output the control voltage VC with a low logic level.

The second transistor M2 may be an NMOS transistor. The second transistor M2 has a control terminal for receiving the control voltage VC, a first terminal coupled to a fourth node N4, and a second terminal coupled to a fifth node N5. In some embodiments, if the control voltage VC has a high logic level, the second transistor M2 will be enabled, and conversely, if the control voltage VC has a low logic level, the second transistor M2 will be disabled.

The sixth diode D6 has an anode coupled to the fourth node N4, and a cathode coupled to the first node N1. The resistor R1 has a first terminal coupled to the first node N1, and a second terminal coupled to the fifth node N5.

The second inductor L2 has a first terminal coupled to the fifth node N5, and a second terminal coupled to the third node N3. The second capacitor C2 has a first terminal coupled to the fifth node N5, and a second terminal coupled to a sixth node N6. The seventh diode D7 has an anode coupled to the sixth node N6, and a cathode coupled to the third node N3. In some embodiments, the second inductor L2 and the first inductor L1 are formed on the same iron core, and thus the second inductor L2 and the first inductor L1 are mutually coupled to each other.

In some embodiments, the operation principles of the buck converter 200 are described as follows. In an initial mode, the buck converter 200 has not received the first input voltage VIN1 and the second input voltage VIN2, and the clock voltage VA is maintained at a low logic level, such that both the first transistor M1 and the second transistor M2 are both disabled. Also, the first diode D1 and the seventh diode D7 are both turned off. Next, after the buck converter 200 receives the first input voltage VIN1 and the second input voltage VIN2, the buck converter 200 may operate in a first mode, a second mode, and a third mode alternately.

In the first mode, the clock voltage VA has a high logic level for enabling the first transistor M1, and the rectified voltage VR is higher than or equal to the output voltage VOUT. Thus, the control voltage VC has a low logic level for disabling the second transistor M2. At this time, the first diode D1 and the seventh diode D7 are both turned off, and the first inductor L1, the second inductor L2, and the second capacitor C2 gradually store energy. It should be noted that since the seventh diode D7 is turned off, the second capacitor C2 does not resonate with the second inductor L2, and there is no resonant voltage/energy affecting the operation of the buck converter 200.

In the second mode, the clock voltage VA has a low logic level for disabling the first transistor M1, and the rectified voltage VR is higher than or equal to the output voltage VOUT. Thus, the control voltage VC has a low logic level for disabling the second transistor M2. At this time, the first diode D1 is turned on, but the seventh diode D7 is turned off. The second inductor L2 and the second capacitor C2 gradually store energy. However, the first inductor L1 releases energy to the first capacitor C1.

In the third mode, regardless of the clock voltage VA having a high or low logic level, the rectified voltage VR is lower than the output voltage VOUT. Thus, the control voltage VC has a high logic level for enabling the second transistor M2. At this time, the buck converter 200 operates under abnormal conditions, and the detection and compensation circuit 260 can automatically readjust the rectified voltage VR. Specifically, the previously stored energy in the second capacitor C2 can be transmitted through the enabled second transistor M2 and the turned-on sixth diode D6 to the first node N1, so as to pull up the level of the rectified voltage VR above the output voltage VOUT. Furthermore, the second inductor L2 can supply energy to the second capacitor C2, so as to maintain the rectified voltage VR at a stable level. Finally, the buck converter 200 will automatically recover and operate under normal conditions.

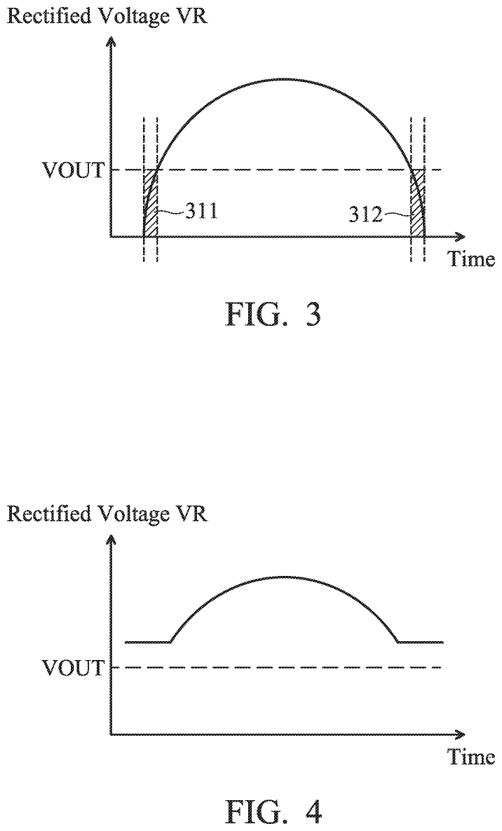

FIG. 3 is a diagram of a waveform of the rectified voltage VR of a conventional buck converter. If the detection and compensation circuit 260 is not used, the conventional buck converter will have at least two dead zones 311 and 312 in every operation cycle (i.e., when the rectified voltage VR is lower than the output voltage VOUT), and it will negatively affect the conversion efficiency of the conventional buck converter.

FIG. 4 is a diagram of a waveform of the rectified voltage VR of the buck converter 200 according to an embodiment of the invention. If the buck converter 200 includes the detection and compensation circuit 260, there will be no dead zone over all of the operation cycles of the buck converter 200 because the rectified voltage VR is always higher than the output voltage VOUT. According to practical measurements, the conversion efficiency of the buck converter 200 using the detection and compensation circuit 260 can be significantly increased.

In some embodiments, the element parameters of the buck converter 200 are described as follows. The capacitance of the first capacitor C1 may be from 646 μF to 714 μF, such as 680 μF. The capacitance of the second capacitor C2 may be from 108 μF to 132 μF, such as 120 μF. The inductance of the first inductor L1 may be from 90.25 μH to 99.75 μH, such as 95 μH. The inductance of the second inductor L2 may be from 36 pH to 44 μH, such as 40 μH. The resistance of the resistor R1 may be from 0.9 KΩ to 1.1 KΩ, such as 1 KΩ. The switching frequency of the clock voltage VA may be about 65 kHz. The above ranges of parameters are calculated and obtained according to the results of many experiments, and they help to optimize the conversion efficiency of the buck converter 200.

The invention proposes a novel buck converter, which includes a detection and compensation circuit. According to practical measurements, the buck converter using the aforementioned design can completely eliminate dead zones in every operation cycle. Generally, the invention can effectively improve the conversion efficiency of the buck converter, and it is suitable for application in a variety of electronic devices.

Note that the above voltages, currents, resistances, inductances, capacitances and other element parameters are not limitations of the invention. A designer can adjust these parameters according to different requirements. The buck converter of the invention is not limited to the configurations of FIGS. 1-4. The invention may merely include any one or more features of any one or more embodiments of FIGS. 1-4. In other words, not all of the features displayed in the figures should be implemented in the buck converter of the invention. Although the embodiments of the invention use MOSFET as examples, the invention is not limited thereto, and those skilled in the art may use other types of transistors, such as BJT (Bipolar Junction Transistor), JFET (Junction Gate Field Effect Transistor), FinFET (Fin Field Effect Transistor), etc., without affecting the performance of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered exemplary only, with the true scope of the disclosed embodiments being indicated by the following claims and their equivalents.

What is claimed is:

1. A buck converter, comprising:
a bridge rectifier, generating a rectified voltage according to a first input voltage and a second input voltage;
a power switch element, selectively coupling the bridge rectifier to a ground voltage according to a clock voltage;
an output stage circuit, generating an output voltage;
a detection and compensation circuit, monitoring and comparing the rectified voltage and the output voltage;
a first inductor, coupled between the detection and compensation circuit and the output stage circuit; and
a first diode, coupled to the detection and compensation circuit and the first inductor;
wherein if it is detected that the rectified voltage is lower than the output voltage, the detection and compensation circuit readjusts the rectified voltage, such that the readjusted rectified voltage is higher than or equal to the output voltage.

2. The buck converter as claimed in claim 1, wherein the bridge rectifier comprises:
a second diode, wherein the second diode has an anode coupled to a first input node for receiving the first input voltage, and a cathode coupled to a first node for outputting the rectified voltage;
a third diode, wherein the third diode has an anode coupled to a second input node for receiving the second input voltage, and a cathode coupled to the first node;
a fourth diode, wherein the fourth diode has an anode coupled to a second node, and a cathode coupled to the first input node; and
a fifth diode, wherein the fifth diode has an anode coupled to the second node, and a cathode coupled to the second input node.

3. The buck converter as claimed in claim 2, wherein the power switch element comprises:
a first transistor, wherein the first transistor has a control terminal for receiving the clock voltage, a first terminal coupled to the second node, and a second terminal coupled to the ground voltage.

4. The buck converter as claimed in claim 2, wherein the first diode has an anode coupled to the ground voltage, and a cathode coupled to a third node.

5. The buck converter as claimed in claim 4, wherein the output stage circuit comprises:
a first capacitor, wherein the first capacitor has a first terminal coupled to an output node for outputting the output voltage, and a second terminal coupled to the ground voltage.

6. The buck converter as claimed in claim 5, wherein the first inductor has a first terminal coupled to the third node, and a second terminal coupled to the output node.

7. The buck converter as claimed in claim 4, wherein the detection and compensation circuit comprises:
a comparator, wherein the comparator has a positive input terminal for receiving the output voltage, a negative input terminal for receiving the rectified voltage, and an output terminal for outputting a control voltage.

8. The buck converter as claimed in claim 7, wherein the detection and compensation circuit further comprises:
a second transistor, wherein the second transistor has a control terminal for receiving the control voltage, a first terminal coupled to a fourth node, and a second terminal coupled to a fifth node.

9. The buck converter as claimed in claim 8, wherein the detection and compensation circuit further comprises:
a sixth diode, wherein the sixth diode has an anode coupled to the fourth node, and a cathode coupled to the first node.

10. The buck converter as claimed in claim 9, wherein the detection and compensation circuit further comprises:
a resistor, wherein the resistor has a first terminal coupled to the first node, and a second terminal coupled to the fifth node.

11. The buck converter as claimed in claim 10, wherein the detection and compensation circuit further comprises:
a second inductor, wherein the second inductor has a first terminal coupled to the fifth node, and a second terminal coupled to the third node.

12. The buck converter as claimed in claim 11, wherein the detection and compensation circuit further comprises:
a second capacitor, wherein the second capacitor has a first terminal coupled to the fifth node, and a second terminal coupled to a sixth node.

13. The buck converter as claimed in claim 12, wherein the detection and compensation circuit further comprises:
a seventh diode, wherein the seventh diode has an anode coupled to the sixth node, and a cathode coupled to the third node.

14. The buck converter as claimed in claim 12, wherein a capacitance of the first capacitor is from 646 μF to 714 μF, and a capacitance of the second capacitor is from 108 μF to 132 μF.

15. The buck converter as claimed in claim 11, wherein an inductance of the first inductor is from 90.25 μH to 99.75 μH, and an inductance of the second inductor is from 36 μH to 44 μH.
